(19) United States
(12) Patent Application Publication
(10) Pub. No.: US 2015/0109877 A1
(43) Pub. Date: Apr. 23, 2015

(54) SYSTEM FOR DISPERSING FINELY DISPERSED SOLIDS IN HIGHLY VISCOUS PRODUCTS

(71) Applicant: EKATO Rühr- und Mischtechnik GmbH, 79650 Schopfheim (DE)

(72) Inventors: Benjamin Multner, Wehr (DE); Klaus Gezork, Schopfheim (DE); Werner Himmelsbach, Rheinfelden (DE)

(21) Appl. No.: 14/117,261

(22) PCT Filed: Jun. 7, 2012
(86) PCT No.: PCT/EP12/02433

§ 371 Date: Nov. 12, 2013

(30) Foreign Application Priority Data
Jun. 15, 2011 (DE) 10 2011 104 272.9

(51) Int. Cl. B01F 3/12; B01F 15/02; B01F 7/16; B01F 15/06; B01F 7/00; B01F 3/14; B01F 15/00

(52) U.S. Cl. CPC B01F 3/1221; B01F 3/14; B01F 15/0283; B01F 15/00422; B01F 15/06; B01F 15/0035; B01F 15/00396; B01F 15/00363; B01F 7/00683; B01F 7/16; B01F 2003/125; B01F 2015/061; B01F 2015/062
USPC 366/138; 366/190; 366/152.2; 366/139; 366/144; 366/152.6; 366/145; 366/151.1

(57) ABSTRACT

A system for dispersing finely dispersed solids into high-viscosity products includes, in a container, a coaxial stirring system having stirring elements on two independently drivable, coaxially arranged shafts. A positive-displacement, close-wall-clearance stirring element on the one shaft and a plurality of stirring elements on a central shaft are arranged in such a manner that, in an upper mixing region of the container, a combination of the positive-displacement, close-wall-clearance stirring element and stirring elements for forming an ideally mixed zone is provided, and in a mixing region downstream of the upper mixing region of the container, stirring elements for developing a plug-flow zone are provided. A positive-displacement pump is provided in a region downstream of the plug flow zone as a discharge zone.

The present invention relates to a system for dispersing finely dispersed solids in highly viscous products.

Highly viscous, thick flowing products into which finely dispersed solids such as finely dispersed silicic acid have to be dispersed, are rheologically characterized by extreme non-newtonian flow characteristics, i.e., they are structurally viscous and often have a high yield point. Typically, they are reactive with air so that contact with air has to be prevented. These products can be produced in the batch operation and in the continuous operation. Examples of such products are silicone sealing compounds, insulating and adhesive compounds, tooth paste, special silicones and all products which have to be produced with short mixing time.

The continuous production typically occurs in extruders with one, two or multiple worm shafts, wherein dual screw extruders are used for the above described highly viscous products. The use of dual screw extruders has the disadvantage that the energy demand is high and also the investing and operating costs are high. Further, using dual screw extruders requires a high minimal throughput thus limiting their suitability for small production amounts. In the case of small production amounts and frequent down times, a system with dual screw extruders is associated with high cleaning efforts. The product is produced at only small back-mixing in the system so that in simple terms a plug-flow or piston flow exists, requiring a very high dosing accuracy. In case of an ideally configured plug-flow, the product flows through the reactor with a flow rate which is constant over the cross section. This is a simplified assumption insofar as a real fluid flows slower at the reactor walls and installations than in the center of the tube and thus resulting in a minor back-mixing.

A batch operation is typically realized with coaxial stirring systems. Usually it consists of close-wall-clearance stirring elements and central-shaft stirring elements which mix the product “ideally”. It is to be noted that in an ideal stirring vessel, the mixing of the product is so efficient that no concentration and temperature gradients occur at any time. This is a simplifying assumption insofar as normally, in a real reactor, solids or fluids added to the product mass differ from the product mass in concentration and temperature. For this reason, even in the case of the very short mixing time achieved by the stirring element, smaller concentration or temperature gradients cannot be avoided. The “ideal” mixing is achieved in a zone I in that the stirring elements ensure significantly shorter mixing times in the zone I than the average retention time of the product.

In the case of products with high yield point, the product is moved out of the stirring container with a stamp because it does not flow freely and cannot be moved out by stirrers according to the state of the art. For pushing the product out of the stirring container, the stirrer first has to be removed from the container which causes product losses. In such a system the effort for cleaning and also the required complexity of the equipment for the stirring tool stamp etc. are high. The device also has to be sealed against air. Due to the size of the system and the mode of operation only a significantly limited throughput can be achieved. Advantages compared to the extruders described above are the small investing costs ad the lower demands on the dosing accuracy.

DE 20 2010 003 100 U1 which is considered as most closely related, shows a system for dispersing finely dispersed solids into highly viscous products, which has a coaxial stirring system with stirring elements on two independently drivable shafts in a container, wherein a force-feeding, close-wall-clearance stirring element is arranged on one of the shafts and multiple stirring elements are arranged on a central shaft.

DE 195 38 476 C2 discloses a system for dispersing finely dispersed solids into highly viscous products with a coaxial stirring system with stirring elements on two coaxially arranged, independently drivable shafts and a force-feeding pump in the region of the output zone.

Based on the state of the art described above, the object of the invention is to provide a system for dispersion of finely dispersed solids into highly viscous products which has a simple construction and can be operated easily and which combines the advantages of the two methods described above and has further advantages. Highly viscous products in this context relate to fluids in a viscosity range of 10.000-1.000.000 mPas at a shearing rate of 10 s⁻¹.

This object is solved by a system for dispersion of finely dispersed solids into highly viscous products as set forth in patent claim 1. The patent claims 2 to 17 set forth advantageous refinements of the present invention.

In particular, a system for dispersion of finely dispersed solids into highly viscous products is provided which has in a container a coaxial stirring system with stirring elements on two coaxially arranged, independently drivable shafts, wherein a positive-displacement, close-wall-clearance stirring system is arranged on one of the shafts and multiple stirring elements are arranged on a one of the central shafts, so that in an upper mixing region of the container directly adjoining an input zone for the starting materials in a head space of the container a combination of the forced delivering close-wall-clearance stirring element and stirring elements is provided for forming an ideally mixed zone, stirring elements are provided in a mixing region downstream of the upper mixing region of the container for forming a plug-flow zone, and a positive-displacement pump and stirring elements in a region downstream of the plug-flow zone form an output zone separate form the mixing regions.

Preferably, a stirring element combination formed by axial flow impellers and dissolver discs is arranged on the central shaft, which combination can be varied depending on the rheology of the product and the demands on the product.

The stirring element combination for forming the ideally mixed zone is in particular arranged and selected so that a homogenization of the liquid, highly viscous phase and of the solid, finely dispersed phase occurs continuously.

As described above, in spite of a very good intermixing in the reactor, a small portion of the added solid material may not be fully dissociated. This task is taken over by the downstream located plug-flow zone. The stirring element combination in the plug-flow zone is arranged and selected so that the complete homogenization of the product for example by complete dissociation of the solids is achieved at small back-mixing or the product.

As a result of the arrangement of the stirring elements and the configuration of the ideally mixed zoned and the following plug-flow zone it is also ensured that no back-mixing of the two zones and in particular no short circuit flow from the input zone of the starting materials to the output zone occurs, but that a minimally required retention time n the mixing zones, i.e., the ideally mixed zone and the plug-flow zone is achieved thereby achieving the homogenization of the product. Preferably, a product-adjusted retention time in the plug-flow zone is set by setting the pump performance of the forced deliver pump of the output zone, and the stirring element combination in the plug-flow zone is preferably arranged and selected so that it causes a complete dissociation of the product which is delivered from the ideally mixed zone.

In the ideally mixed zone and in the plug-flow zone a dissolver disc and an axial flow impeller are preferably typically provided on the central shaft as stirring elements.

The system is in particular configured so that it carries out a mixing of the liquid, highly viscous phase and the solid, finely dispersed phase in the batch operation or in the continuous operation.

The ideally mixed zone and the plug-flow zone are in particular combined so that the correct combination of the ideally mixed zone with the plug-flow zone compensates short-time fluctuations in dosing so that the demands on accuracy of dosing over time of the liquid and solid phase are low. In particular the demands are lower than in methods according to the current state-of-the-art. The correct combination of the ideally mixed zone and the plug-flow zone and coordinating the respective pump capacity of the stirring system with the forced delivery pump compensates short time fluctuations of the dosing without adversely affecting the quality of the finished product.

Preferably, the pump capacity of the stirring system and the capacity of the positive-displacement pump are coordinated with each other so that none of the two causes a short circuit.

Further, the stirring system in the ideally mixed zone and the positive-displacement pump in the output zone are provided in combination so that during operation Le., in the continuous operation and/or in the batch operation, the mixing process and the output process are separated from each other.

At the head of the container, devices for adding liquids and solids can be provided. The devices for adding the finely dispersed solids have in particular a rotary feeder and/or a device for volumetric delivery which can be used in accordance with the mode of operation.

At the head of the container, a device or devices for adding for example nitrogen and/or a device for applying a vacuum for degassing the product can be provided.

Preferably, devices for carrying out mixing processes of different liquid and solid phases are located upstream of the system.

Preferably, devices for cleaning the system are located upstream of the system.

Preferably, devices for carrying out processing procedures such as the complete degassing of the product are located downstream of the system.

Preferably, a device for cooling or heating the system is provided depending on the product.

Advantageously, measuring and cleaning devices for the reliable control of for example flow-through, temperature, filling level etc of the system are provided.

The system according to the invention combines the advantages of the aforementioned systems for a continuous production and a batch operation. On one hand, the simpler coaxial steering tool is used, on the other hand the mixing regions i.e., the ideal mixing and the plug-flow of the two systems are combined. In addition, the system is suited for mixing the liquid, highly viscous phase and the solid, finely dispersed phase in the batch operation as well as in the continuous operation.

The mentioned features and further features and details of the invention will become more apparent for a person with skill in the art from the following detailed description and the included drawing, which shows features of the present invention by way of an example and wherein:

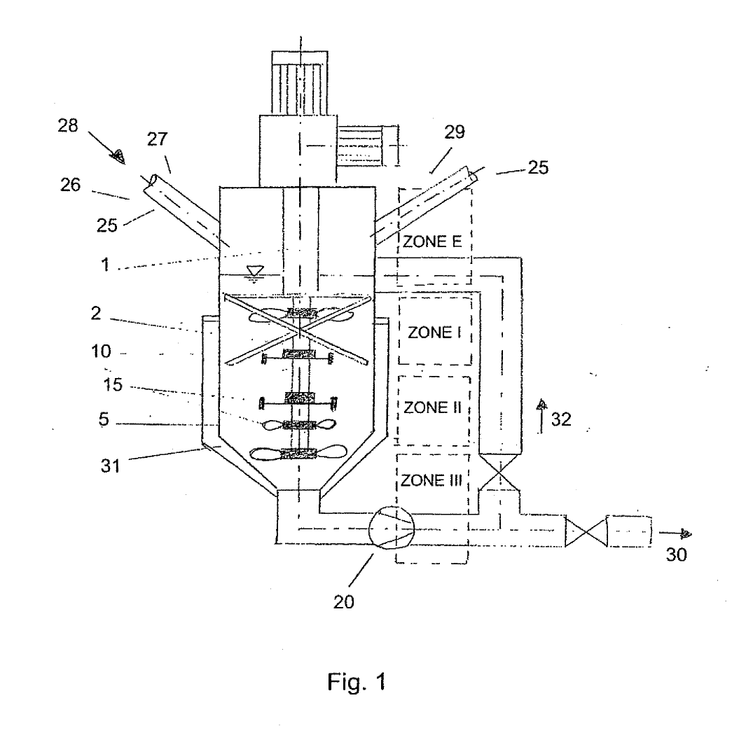

FIG. 1 shows a system according to the invention for dispersion of finely dispersed solids in highly viscous products.

The system shown in FIG. 1 for dispersion of finely dispersed solids into highly viscous products has a container 5, a coaxial steering system 10, 15 with steering elements on two coaxially arranged, independently drivable shafts 1, 2. A positive-displacement close-wall-clearance stirring element 10 on one of the shafts 1 and multiple stirring elements 15 on a central shaft are arranged so that in an upper mixing region of the container 5 directly adjoining an input zone E, a combination of the positive-displacement, close-wall-clearance stirring element 10 and stirring embers 15 for forming an ideally mixed zone I is provided and in a mixing region, which is located downstream of the upper mixing region of the container, stirring elements 15 for forming a plug-flow zone II are provided. Further, a positive-displacement pump 20 and stirring elements 15 are provided in a region configured as output zone Ill downstream of the plug-flow zone II.

The positive-displacement, close-wall-clearance stirring element 10 is variable depending on the rotational speed and feed direction.

The stirring elements 15 are formed by a stirring element combination of axial flow impellers and dissolver discs arranged on the central shaft 2, which can be varied depending on the rheology of the product and demands on the product. The stirring element combination for forming the ideally mixed zone I is in particular arranged and selected so that the homogenization of the liquid, highly viscous phase and the solid, finely dispersed phase occurs continuously. Further, by setting the pump capacity of the forced delivery pump 20 of the output zone III, a retention time which is adjusted to the product is set and the stirring element combination in the plug-flow zone II is arranged and selected so that it causes a complete dissociation of the product delivered from the ideally mixed zone I. In the ideally mixed zone and in the plug-flow zone II at least one dissolver disc and an axial flow impeller are typically provided as stirring elements 15 on the central shaft 2.

In the output zone III, the positive-displacement pump 20 is integrated in the container 5. The pump capacity of the coaxial stirring system 10, 15 and the pump capacity of the output pump 20 are coordinated with each other. The stirring system 10, 15 in the ideally mixed zone I and the plug-flow zone II, and the positive-displacement pump 20 in the output zone III are provided in combination so that during operation i.e., in the continuous operation or in the batch operation, mixing and output processes are separated from each other. The batch operation is in particular established by causing a re-circulation of the product via a re-circulation line 32 and closing of the output valve.

As can be seen in FIG. 1, devices 25 for adding liquids and solids are provided at the head of the container 5. The devices 25 for adding finely dispersed solids have a central rotary feeder and/or a device for volumetric delivery which are utilized depending on the mode of operation. The added products i.e, liquids and solids are ideally mixed in zone I. According to the invention, the demands on the dosing accuracy are decreased because the separation into different mixing zones I and H can compensate fluctuating input amounts.

In particular, short-time fluctuations in dosing accuracy between the input zone E and the output zone III are compensated as a result of the back-mixing obtained in the ideally mixed zone I. The degree of back-mixing is for example adjusted via the rotational speed of the positive-displacement, wall-proximate stirring element 10 and the variability of the pump flow rate in the ideally mixed zone I associated therewith and the pump capacity and delivery capacity of the positive-displacement pump 20.

Further, FIG. 1 shows that a device 26 for adding for example nitrogen and a device 27 for applying a vacuum for degassing the product are provided at the head of the container 5.

The optional application of a vacuum to the head of the container 5 and the separation into different mixing zones (zone I and II), allows meeting demands on quality regarding for example residual air enclosures. A corresponding adjustment of the dosing units for example a solid material dosing with rotary feeder is required. This is not possible in the above described continuous production of products in extruders. In these extruders separate degassing units (zones) have to be arranged downstream.

Also, devices 28 for carrying out mixing processes of different liquid and solid phases are arranged upstream of the system shown in FIG. 1. The mixing processes include for example the mixing-in of fillers and dyes and/or the mixing-in of hardeners.

Also, devices 29 for cleaning the system are arranged upstream of the system shown in FIG. 1.

Also, devices 30 for carrying out processing processes such as the complete degassing of the product are arranged downstream of the system shown in FIG. 1. The processing steps can for example also include the mixing in of fillers and dyes and/or the mixing in of hardeners.

In addition, a device 31 for cooling or heating the system is also provided depending on the product.

In summary, the invention provides the following advantages:

A simple system technology is used while the throughput and the quality of a product is not worse compared to a production in a system according to the state of the art. The investing costs are lower at the same throughput and same quality compared to the state of the art. The operating costs are lower compared to the state of the art because the system operates more cost effectively at same throughput and same quality compared to the state of the art. According to the invention, a continuous operation as well as a batch operation are possible on the same system. In the system according to the invention, small throughputs are also possible in the continuous operation (˜100 kg/h). In the system, the mixing and the output process in the continuous operation are principally separated. Small batch amounts are also possible.

The plug-flow in the extruder requires a high dosing accuracy. Compared to this, the system according to the invention operates with a combination of ideally mixed zone and plug-flow zone. This places lower demands on the dosing accuracy and with this lower investing and operating costs for the dosing units.

What is claimed is:

1.-17. (canceled)

18. A system for dispersion of finely dispersed solids into highly viscous products, comprising:
a container having a head space defining an input zone for adding starting material;
two coaxially arranged, independently drivable shafts received in the container;
a positive-displacement, close-wall-clearance stirring element arranged on one of the two shafts;
plural stirring elements arranged on a central one of the two shafts; and
a positive-displacement pump,
wherein first ones of the plural stirring elements and the close-wall-clearance stirring element are arranged in an upper mixing region of the container directly adjoining the input zone and together define an ideally mixed zone,
wherein second ones of the plural stirring elements are arranged in a mixing region downstream of the upper mixing region so as to define a plug-flow zone, and
wherein third ones of the stirring elements together with the positive-displacement pump define an output zone in a region located downstream of the plug-flow zone and separate from the mixing regions.

19. The system of claim 18, wherein the plural stirring elements comprise axial flow impellers and dissolver discs, and wherein a combination of the axial flow impellers and dissolver discs is variable depending on a rheology of the product and demands on the product.

20. The system of claim 19, wherein the first stirring elements and the close-wall-clearance stirring element are arranged so as to effect a continuous homogenization of a liquid, highly viscous phase and a solid, finely dispersed phase.

21. The system of claim 19, wherein a performance of the positive displacement pump is set so that a retention time of a product in the plug-flow zone is adjusted to the product, and wherein the second stirring elements are arranged and selected so as to effect a complete dissociation of the product delivered from the ideally mixed zone.

22. The system of claim 18, wherein the first and second stirring elements each comprise at least one dissolver disc and at least one axial flow impeller.

23. The system of claim 18, constructed for effecting a mixing of a liquid, highly viscous phase and a solid, finely dispersed phase in a batch operation or in a continuous operation.

24. The system of claim 18, wherein the ideally mixed zone and the plug-flow zone are combined with each other and the pump capacity of the stirring system and the pump capacity of the positive-displacement pump are adjusted to each other so as to compensate short time fluctuations in dosing.

25. The system of claim 18, wherein the pump capacity of the stirring system and a capacity of the positive displacement pump are adjusted to one another so that neither the stirring system nor the positive displacement pump causes a short circuit.

26. The system of claim 18, wherein the stirring system in the ideally mixed zone and the plug-flow zone and the positive-displacement pump in the output zone are provided in such combination that during continuous and/or batch operation mixing and output processes are separated from each other.

27. The system of claim 18, further comprising devices on a head of the container for adding liquids and solids.

28. The system of claim 27, wherein the devices for adding the solids include a rotary feeder or a device for volumetric delivery, which are used depending on a mode of operation of the system.

29. The system of claim 18, further comprising on a head of the container at least one of devices for adding nitrogen and a device for applying a vacuum for degassing the product.

30. The system of claim 18, further comprising devices for carrying out mixing processes of different liquid and solid phases arranged upstream of the system.

31. The system of claim 18, further comprising devices for cleaning the system arranged upstream of the system.

32. The system of claim 18, further comprising processing devices arranged downstream of the system.

33. The system of claim 32, wherein the processing devices are constructed for degassing the product.

34. The system of claim 18, further comprising a device for cooling or heating the system, depending on the product.

35. The system of claim 18, further comprising measuring and control devices for reliable control of at least one of flow rate, temperature and filling level of the system.
